(19) United States
(12) Patent Application Publication
(10) Pub. No.: US 2018/0014461 A1
(43) Pub. Date: Jan. 18, 2018

(54) Miniature Weed Trimming Assembly

(71) Applicant: Mary Brewer, Houston, TX (US)

(72) Inventor: Mary Brewer, Houston, TX (US)

(21) Appl. No.: 15/211,892

(22) Filed: Jul. 15, 2016

(51) Int. Cl. A01D 34/90; A01D 34/416

(52) U.S. Cl. CPC A01D 34/90; A01D 34/4167

(57) ABSTRACT

A miniature weed trimming assembly for trimming weeds around ornamental plants includes a handle that may be manipulated. The handle has a length ranging between forty cm and sixty cm. A cutting unit is coupled to the handle and the cutting unit may cut plants when the handle is manipulated. A control is coupled to the handle and the control may be manipulated. The control is electrically coupled to the cutting unit and the control controls operational parameters of the cutting unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to trimming devices and more particularly pertains to a new trimming device for trimming weeds around ornamental plants.

### BRIEF SUMMARY OF THE INVENTION

An embodiment of the disclosure meets the needs presented above by generally comprising a handle that may be manipulated. The handle has a length ranging between forty cm and sixty cm. A cutting unit is coupled to the handle and the cutting unit may cut plants when the handle is manipulated. A control is coupled to the handle and the control may be manipulated. The control is electrically coupled to the cutting unit and the control controls operational parameters of the cutting unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a miniature weed trimming assembly according to an embodiment of the disclosure.

FIG. 2 is a left side view of an embodiment of the disclosure.

FIG. 3 is a back view of an embodiment of the disclosure.

FIG. 4 is a bottom phantom view of an embodiment of the disclosure.

FIG. 5 is a cross sectional view taken along line 5-5 of FIG. 4 of an embodiment of the disclosure.

FIG. 6 is a perspective in-use view of an embodiment of the disclosure.

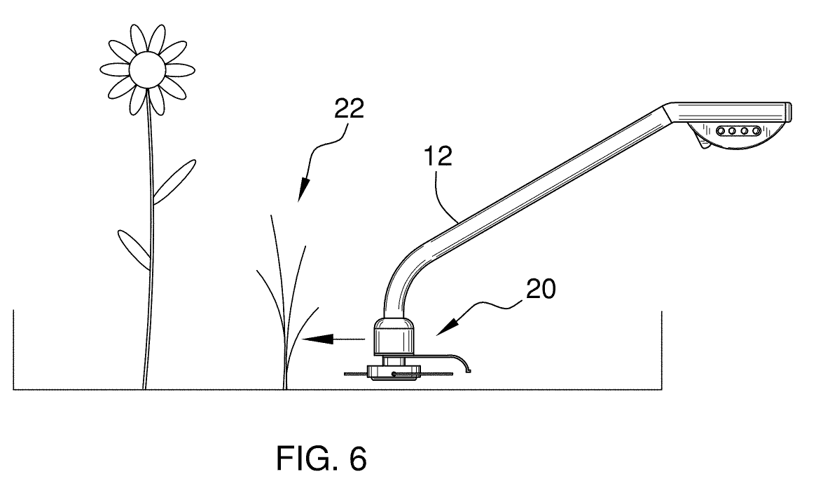

### DETAILED DESCRIPTION OF THE INVENTION

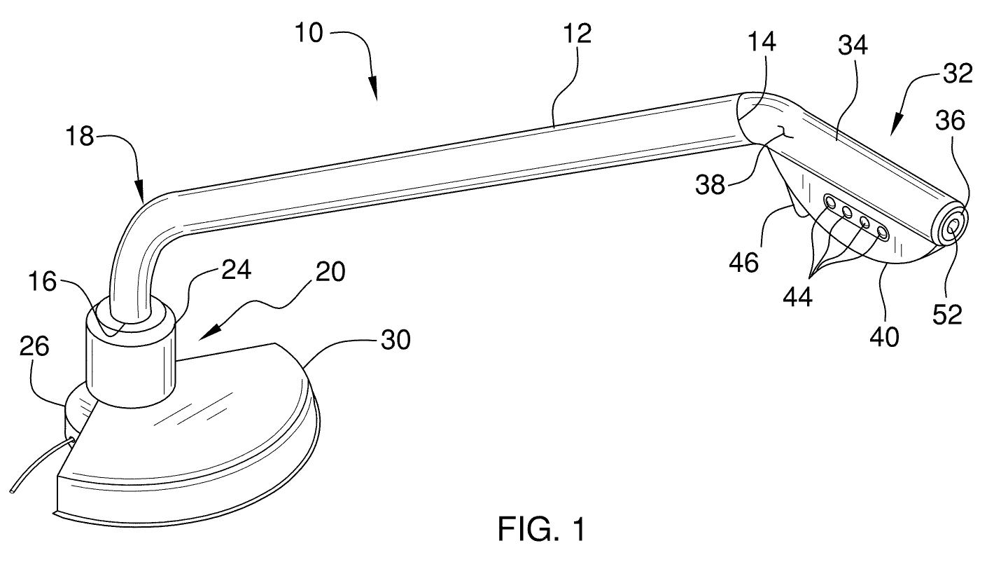

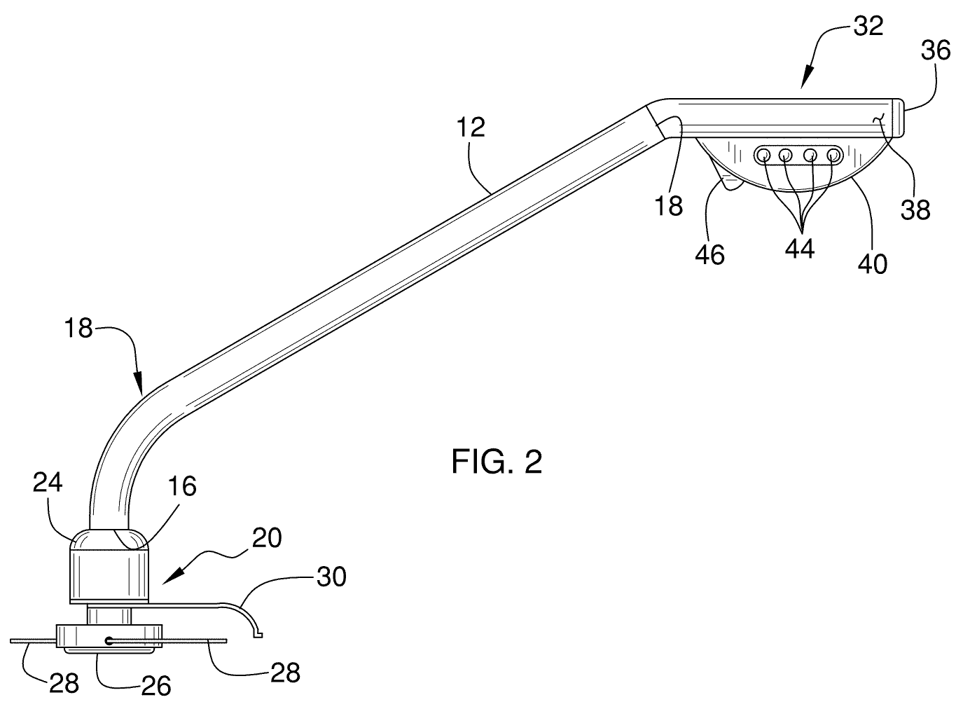

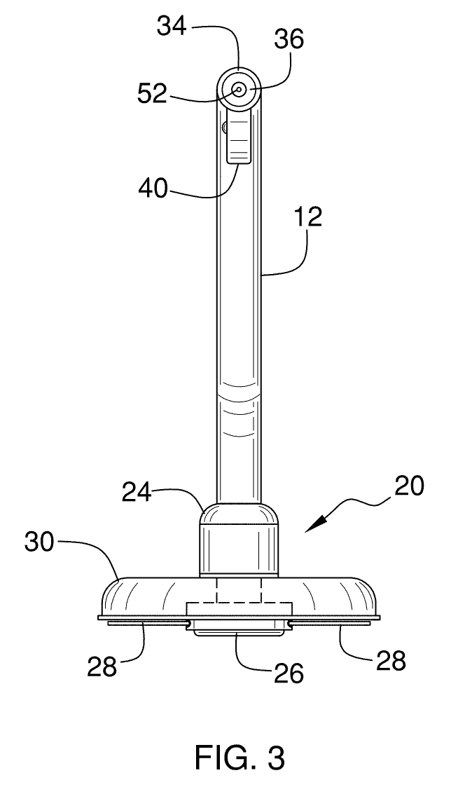

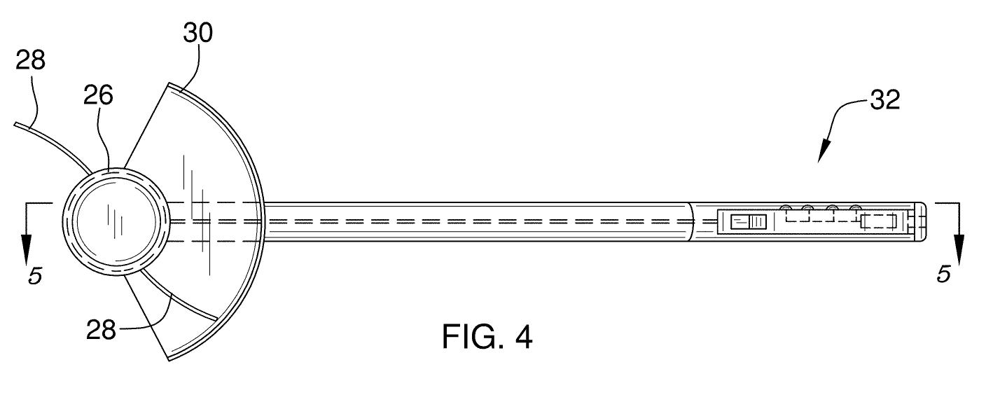

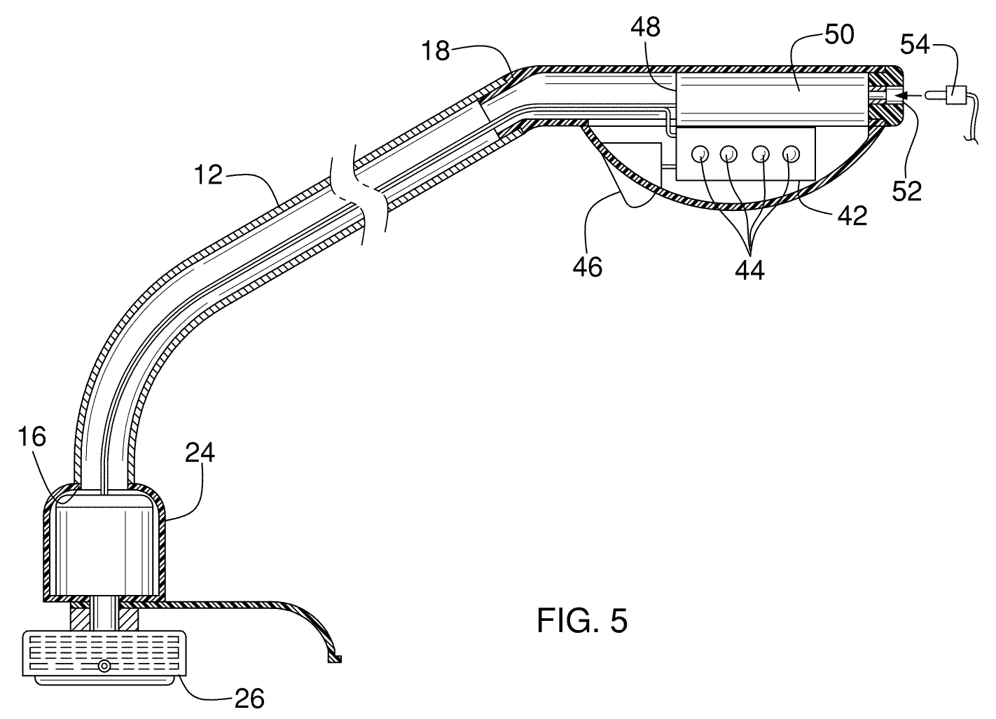

With reference now to the drawings, and in particular to FIGS. 1 through 5 thereof, a new trimming device embodying the principles and concepts of an embodiment of the disclosure and generally designated by the reference numeral 10 will be described.

As best illustrated in FIGS. 1 through 5, the miniature weed trimming assembly 10 generally comprises a handle 12 that may be manipulated. The handle 12 has a length ranging between forty cm and sixty cm. The handle 12 has a first end 14 and a second end 16. Moreover, the handle 12 has a first bend 18 thereon. The first bend 18 is positioned closer to the second end 16 than the first end 14.

A cutting unit 20 is coupled to the handle 12. The cutting unit 20 cuts plants 22 when the handle 12 is manipulated. The plants 22 may be weeds or the like and the plants 22 may be growing in a flower pot or a flower bed. The cutting unit 20 may have a diameter ranging between seven cm and ten cm. Thus, the cutting unit 20 may be positioned in a restricted area.

The cutting unit 20 comprises a motor 24 that is coupled to the second end 16 of the handle 12. The motor 24 may comprise an electrical motor or the like. A wire spool 26 is coupled to the motor 24. The motor 24 rotates the wire spool 26 when the motor 24 is turned on.

The wire spool 26 includes a pair of wires 28 extending outwardly therefrom. Thus, each of the wires 28 may cut the plant when the motor is turned on. The wire spool 26 may comprise a weed eater wire spool or the like. A shield 30 is coupled to the motor 24 and the shield 30 substantially covers the wire spool 26.

A control 32 is provided. The control 32 is coupled to the handle 12 and the control 32 may be manipulated. The control 32 is electrically coupled to the cutting unit 20. Thus, the control 32 controls operational parameters of the cutting unit 20.

The control 32 comprises a housing 34 that is coupled to the first end 14 of the handle 12. The housing 34 has a distal end 36 with respect to the first end 14 and an outer surface 38. The housing 34 includes a fin 40 extending downwardly from the outer surface 38. The fin 40 enhances gripping the handle 12.

A processor 42 is positioned within the housing 42 and the processor 42 is electrically coupled to the motor 24. The processor 42 may comprise an electronic processor 42 or the like. A plurality of buttons 44 is provided. Each of the buttons 44 is coupled to the outer surface 38 of the housing 42 and each of the buttons 44 may be manipulated. Each of the buttons 44 is electrically coupled to the processor 42 and each of the buttons 44 controls operational parameters of the motor 24.

The plurality of buttons 44 may include an on button, an off button, a pulse button and a reverse button. The on button may turn the motor 24 on and the off button may turn the motor 24 off. The pulse button may actuate the motor 24 to pulse between being on and off. The reverse button may reverse a rotational direction of the motor 24.

A trigger 46 is provided. The trigger 46 is movably coupled to the fin 40 and the trigger 46 may be manipulated. The trigger 46 is electrically coupled to the processor 42. The trigger 46 turns the motor 24 on when the trigger 46 is manipulated.

A power supply 48 is coupled to the control 32 and the power supply 48 is electrically coupled to the processor 42. The power supply 48 comprises at least one battery 50 and a charge port 52 that is coupled to the distal end 36 of the housing 34. The charge port 52 is electrically coupled to the at least one battery 50. The charge port 52 may be electrically coupled to a power source 54 thereby facilitating the at least one battery 50 to be charged. The power source 54 may comprise a battery charger or the like.

In use, the handle 12 is manipulated to position the cutting unit 20 in the restricted area such as a flower bed or the like. Selected ones of the buttons 44 are manipulated and the trigger 46 is manipulated to rotate the wire spool 26. The length of the handle 12 facilitates precise manipulation of the cutting unit 20. Thus, the cutting unit 20 may trim weeds in the flower bed without damaging ornamental plants in the flower bed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A miniature weed trimming assembly being configured to remove weeds in a flower bed or the like, said assembly comprising:
a handle being configured to be manipulated, said handle having a length ranging between forty cm and sixty cm;
a cutting unit being coupled to said handle wherein said cutting unit is configured to cut plants when said handle is manipulated; and
a control being coupled to said handle wherein said control is configured to be manipulated, said control being electrically coupled to said cutting unit such that said control controls operational parameters of said cutting unit.

2. The assembly according to claim 1, wherein said cutting unit comprises a motor being coupled to a second end of said handle.

3. The assembly according to claim 2, further comprising a wire spool being coupled to said motor such that said motor rotates said wire spool when said motor is turned on, said wire spool including a pair of wires extending outwardly therefrom wherein each of said wires is configured to cut the plant when said motor is turned on.

4. The assembly according to claim 3, further comprising a shield being coupled to said motor such that said shield substantially covers said wire spool.

5. The assembly according to claim 1, wherein said control comprises a housing being coupled to a first end of said handle, said housing having a distal end with respect to said first end, said housing having an outer surface, said housing including a fin extending downwardly from said outer surface wherein said fin is configured to enhance gripping said handle.

6. The assembly according to claim 5, further comprising:
a motor; and
a processor being positioned within said housing, said processor being electrically coupled to said motor.

7. The assembly according to claim 6, further comprising a plurality of buttons, each of said buttons being coupled to said outer surface of said housing wherein each of said buttons is configured to be manipulated, each of said buttons being electrically coupled to said processor such that each of said buttons controls operational parameters of said motor.

8. The assembly according to claim 7, further comprising a trigger being movably coupled to said fin wherein said trigger is configured to be manipulated, said trigger being electrically coupled to said processor, said trigger turning said motor on when said trigger is manipulated.

9. The assembly according to claim 8, further comprising a power supply being coupled to said control, said power supply being electrically coupled to said processor.

10. The assembly according to claim 9, wherein said power supply comprises:
at least one battery; and
a charge port being coupled to said distal end of said housing, said charge port being electrically coupled to said at least one battery, said charge port being configured to be electrically coupled to a power source thereby facilitating said at least one battery to be charged.

11. A miniature weed trimming assembly being configured to remove weeds in a flower bed or the like, said assembly comprising:
a handle being configured to be manipulated, said handle having a length ranging between forty cm and sixty cm, said handle having a first end and a second end, said handle having a first bend thereon, said first bend being positioned closer to said second end than said first end;
a cutting unit being coupled to said handle wherein said cutting unit is configured to cut plants when said handle is manipulated, said cutting unit comprising:
a motor being coupled to said second end of said handle,
a wire spool being coupled to said motor such that said motor rotates said wire spool when said motor is turned on, said wire spool including a pair of wires extending outwardly therefrom wherein each of said wires is configured to cut the plant when said motor is turned on, and
a shield being coupled to said motor such that said shield substantially covers said wire spool; and
a control being coupled to said handle wherein said control is configured to be manipulated, said control being electrically coupled to said cutting unit such that said control controls operational parameters of said cutting unit, said control comprising:
a housing being coupled to said first end of said handle, said housing having a distal end with respect to said first end, said housing having an outer surface, said housing including a fin extending downwardly from said outer surface wherein said fin is configured to enhance gripping said handle,
a processor being positioned within said housing, said processor being electrically coupled to said motor,
a plurality of buttons, each of said buttons being coupled to said outer surface of said housing wherein each of said buttons is configured to be manipulated, each of said buttons being electrically coupled to said processor such that each of said buttons controls operational parameters of said motor,
a trigger being coupled to said fin wherein said trigger is configured to be manipulated, said trigger being electrically coupled to said processor, said trigger turning said motor on when said trigger is manipulated, and
a power supply being coupled to said control, said power supply being electrically coupled to said processor, said power supply comprising:
at least one battery, and
a charge port being coupled to said distal end of said housing, said charge port being electrically coupled to said at least one battery, said charge port being configured to be electrically coupled to a power source thereby facilitating said at least one battery to be charged.
